(19) United States
(12) Patent Application Publication
(10) Pub. No.: US 2024/0240343 A1
(43) Pub. Date: Jul. 18, 2024

(54) ELECTROCHEMICAL METHOD FOR SEPARATION OF ZIRCONIUM AND HAFNIUM

(71) Applicant: ZHENGZHOU UNIVERSITY, Zhengzhou (CN)

(72) Inventor: Zhongwei ZHAO, Zhengzhou (CN)

(73) Assignee: ZHENGZHOU UNIVERSITY, Zhengzhou (CN)

(21) Appl. No.: 18/289,708

(22) PCT Filed: Apr. 21, 2022
(86) PCT No.: PCT/CN2022/088121

§ 371 Date: Nov. 6, 2023

(30) Foreign Application Priority Data
May 8, 2021 (CN) 202110499871.2

(51) Int. Cl. C25C 3/26

(52) U.S. Cl. CPC C25C 3/26

(57) ABSTRACT

The present disclosure provides an electrochemical method for the separation of zirconium and hafnium, using an electrolytic cell equipped with an anode chamber and a cathode chamber, wherein the anode chamber and the cathode chamber are separated by a liquid alloy. In particular, the liquid alloy comprises a crude zirconium and a matrix metal with the metal activity lower than zirconium. After the electrolysis reaction is started, since the metal activity series in the liquid alloy is: hafnium>zirconium>>matrix metal, the hafnium in the liquid alloy is oxidized prior to the zirconium, the hafnium in ionic form migrates into the cathode electrolyte in the cathode chamber, leading to a continuous decrease of hafnium content in the liquid alloy, whereas the zirconium remains in the liquid alloy. Accordingly, deep separation of zirconium from hafnium is achieved, and therefore, nuclear-grade zirconium products can be prepared.

### TECHNICAL FIELD

The present disclosure relates to the technical field of zirconium metallurgy, in particular to an electrochemical method for the separation of zirconium and hafnium.

### BACKGROUND

Zirconium and hafnium both belong to the category of high-melting-point rare metals and are widely used in sectors such as aerospace, space, nuclear energy, metallurgy, chemical engineering, medical, and more. The thermal neutron capture cross-section of hafnium is large, standing at 115b, whereas that of zirconium is merely 0.18b, therefore, the hafnium content in the zirconium cladding shell for uranium nuclear fuel needs to be reduced to an extremely low level (100 ppm). However, since zirconium and hafnium both belong to the subgroup IV elements, the atomic and ionic radii and structures are very similar, the chemical properties are also very similar, consequently, zirconium and hafnium often coexist in nature (hafnium accounting for about 1-2% of the total mass of zirconium and hafnium), making their separation during the smelting process quite challenging. With the global energy structure undergoing transformation, the nuclear industry's demand for nuclear-grade zirconium continues to rise, therefore the development of new zirconium-hafnium separation processes has significant strategic importance.

Since the middle of last century, developed countries have conducted extensive research on the separation of zirconium and hafnium, mainly including solvent extraction, fractional crystallization, and molten salt extraction. Among them, the solvent extraction method mainly focuses on the difference in properties of ZrO²⁺ and HfO²⁺ in aqueous solution, for instance, due to differences in coordination capability with SCN, methyl isobutyl ketone (MIBK) is used for extraction separation, for differences in phospho-oxygen coordination capability, tributyl phosphate (TBP) is used for extraction separation, and the N235 extraction method, etc. However, due to the issues such as the water solubility losses and volatilization of organic extracting agents, this category of method still needs further improvements and refinements; the fractional crystallization method utilizes the solubility differences of zirconium and hafnium compounds for separation, for instance, the solubility of K₂HfF₆ is twice that of K₂ZrF₆, and there are distinct differences in the water-soluble properties between zirconium and hafnium phosphates and ferricyanide compounds, however, due to low efficiency, this type of method was primarily found in early research; moreover, there is the distillation method that exploits the molecular weight differences between ZrCl₄ and HfCl₄, but it has the disadvantages of high operating temperature and significant energy consumption.

Since the 1970s, Megy et al. have developed a molten salt extraction method based on the differences in the redox properties between the molten salts and metals of zirconium, hafnium and their halides. The basic principle is that the hafnium metal in the high-temperature liquid alloy (zinc-zirconium-hafnium) reacts with the zirconium ions in the molten salt, the zirconium remains in the liquid alloy, and the hafnium migrates into the molten salt, therefore achieving the separation of zirconium and hafnium; on this basis, researchers from Delft University of Technology in the Netherlands mixed zirconium and hafnium with copper-tin to form a liquid alloy, utilizing hafnium's stronger reduction ability than zirconium, hafnium reduces the copper ions in the molten salt and migrate into the molten salt, so that the hafnium in the liquid metal is oxidized and migrates into the molten salt, the copper ions in the molten salt are reduced and migrate into the liquid alloy, whereas the zirconium remains in the liquid alloy, therefore realizing the removal of the hafnium. However, the addition of copper ions not only oxidize hafnium, but also oxidize a large amount of zirconium, which means it is difficult to control the oxidation rate of zirconium and hafnium in the liquid alloy. Therefore, although the separation coefficient of zirconium and hafnium in actual experimental research reaches about 600, in the reaction process, due to the oxidation caused by the copper ions, when hafnium is removed by 99.5%, the loss of zirconium is as high as 44%.

In summary, in view of the issues within the existing technology, it is necessary to develop an efficient separation technology for zirconium and hafnium.

### SUMMARY

The present disclosure provides an electrochemical method for the separation of zirconium and hafnium, by employing an electrochemical approach to control the oxidation rate, the hafnium in the liquid alloy is oxidized slowly, lower the loss of the zirconium, therefore achieving a deep separation of zirconium and hafnium. The method comprises:
An electrolytic cell equipped with an anode chamber and a cathode chamber is used, wherein there is an anode electrolyte in the anode chamber and there is a cathode electrolyte in the cathode chamber, an anode is inserted into the anode electrolyte, a cathode is inserted into the cathode electrolyte; the anode chamber and the cathode chamber are separated by a liquid alloy, and both the anode and the cathode are not in contact with the liquid alloy;
the liquid alloy comprises solute metal and matrix metal, and the solute metal is crude zirconium. Since zirconium and hafnium usually coexist in nature, the crude zirconium contains a portion of hafnium. Furthermore, the mass percentage of hafnium in the crude zirconium is ≤5%, preferably 1-2%; the metal activity of the matrix metal is lower than the metal activity of zirconium;
after the electrolysis reaction is started, since the metal activity series in the liquid alloy is: hafnium>zirconium>>matrix metal, the hafnium in the liquid alloy is oxidized prior to the zirconium, the hafnium in ionic form migrates into the cathode electrolyte, leading to a continuous decrease of hafnium content in the liquid alloy, whereas the zirconium remains in the liquid alloy and therefore, the separation of zirconium from hafnium is achieved.

Furthermore, the material of the anode is selected from one of graphite, copper, and crude zirconium. The content of hafnium in the crude zirconium in the anode is the same as the content of hafnium in the crude zirconium as a solute metal.

Furthermore, when the material of the anode is graphite, a zirconium-containing material need to be added into the anode chamber, the zirconium-containing material is a halide or an oxide of zirconium, preferably selected from one or several of Na₂ZrCl₆, K₂ZrCl₆, Na₂ZrF₆, K₂ZrF₆, ZrO₂, ZrCl₂, ZrCl₃, ZrCl₄. Furthermore, when the material of the anode is copper or crude zirconium, there is no need to add the zirconium-containing materials into the anode chamber.

Furthermore, the matrix metal is selected from one or several of copper, lead, zinc, tin, and bismuth, and the melting point of the liquid alloy formed by the solute metal and the matrix metal is lower than 1100° C. The principle for selecting each component and proportion in the liquid alloy is: first the operating temperature of the electrolytic cell is determined, and then the metal composition in the liquid alloy is determined. According to the alloy phase diagram of the zirconium and the matrix metal, the ratio of the zirconium and the matrix metal used in the liquid alloy is determined, that the selected alloy components are in a molten state at the operating temperature is ensured.

When the material of the anode is copper, the anode electrolyte is selected from one or several of CuCl₂ and LiF, NaF, KF, LiCl, NaCl, KCl, CaCl₂. When the material of the anode is graphite or zirconium, the anode electrolyte is selected from one or several of ZrCl₄, ZrCl₂, ZrCl₃, Na₂ZrF₆, K₂ZrF₆ or one or several of LiF, NaF, KF, LiCl, NaCl, KCl, CaCl₂). The cathode electrolyte is selected from one or several of LiF, NaF, KF, LiCl, NaCl, KCl, CuCl₂, there are a zirconium halide and/or a hafnium halide dissolved in the cathode electrolyte, and the zirconium halide and/or the hafnium halide are selected from one or several of ZrCl₄, ZrCl₂, ZrCl₃, HfCl₄, HfCl₂, HfCl₃, Na₂ZrCl₆, K₂ZrCl₆, Na₂HfCl₆, K₂HfCl₆, Na₂ZrF₆, K₂ZrF₆, Na₂HfF₆, K₂HfF₆. There are no specific requirements for the adding ratio of the zirconium halide and/or the hafnium halide to other molten salts. In principle, as long as the cathode electrolyte and anode electrolyte are in a molten state at the operating temperature of the electrolytic cell, and both the density of the cathode electrolyte and the density of the anode electrolyte are lower than the density of the liquid alloy, ensuring the liquid electrolyte floats on the top of the liquid alloy.

Furthermore, the material of the cathode is stainless steel, zirconium, titanium or tungsten.

Furthermore, the electrolysis reaction is carried out under the protection of argon gas, the electrolysis reaction temperature is 400-1100° C., an electric field is applied between the anode and the cathode, and the current density is controlled at 0.002-0.5 A·cm⁻².

When the material of the anode is graphite, a zirconium-containing material which is a zirconium halide or a zirconium oxide needs to be added to the anode chamber through the zirconium-containing material feeding port. At this time, the reaction process is as follows: An inert gas is introduced into the electrolytic cell through the gas inlet, and the body of the electrolytic cell is heated by resistance wire to carry out the electrolysis reaction. The zirconium-containing material added to the anode chamber gains electrons and is reduced to zirconium metal at the interface formed between the anode electrolyte and the liquid alloy, and the zirconium metal is dissolved into the liquid alloy; meanwhile, because the metal activity series in the liquid alloy is: hafnium>zirconium>>matrix metal, and the liquid alloy loses electrons during the above-mentioned anode reaction process, therefore the hafnium metal loses electrons and is oxidized prior to the zirconium metal and the matrix metal, generating the hafnium ions and migrate into the cathode electrolyte. In the above-mentioned electrolysis reaction, the hafnium metal in the liquid alloy continuously converts into the hafnium ions and the hafnium ions continuously migrate into the cathode electrolyte, whereas the zirconium remains in the liquid alloy, therefore the separation of zirconium and hafnium is achieved.

When the material of the anode is copper or crude zirconium, there is no need to add the zirconium-containing material into the anode chamber. Specifically:

When the material of the anode is copper and the component of the matrix metal in the liquid alloy is also copper, the electrolysis reaction process is as follows: the electrolytic cell is powered and operated under the protection of an inert gas, the anode is oxidized and loses electrons, the copper used as the anode is oxidized, the copper in cationic form migrates into the anode electrolyte, the copper cations in the anode electrolyte are reduced to the copper metal at the interface between the anode electrolyte and the liquid alloy, and the copper metal as the component of the matrix metal migrates into the liquid alloy. According to the metal activity series of hafnium>zirconium>>matrix metal, the hafnium metal in the liquid alloy is oxidized prior to the zirconium metal, the hafnium in ionic form migrates into the cathode electrolyte. In the above-mentioned process, since the hafnium is oxidized and migrates into the cathode electrolyte prior to the zirconium, the content of the hafnium in the liquid alloy continuously decreases, therefore achieving the separation of zirconium and hafnium.

When the material of the anode is crude zirconium, the electrolysis reaction process is as follows: the electrolytic cell is powered and operated under the protection of an inert gas, the anode is oxidized and loses electrons, the crude zirconium used as the anode is oxidized, the zirconium in cationic form migrates into the anode electrolyte, the zirconium cations in the anode electrolyte are reduced to the zirconium metal at the interface between the anode electrolyte and the liquid alloy, and then the zirconium metal migrates into the liquid alloy. In this process, since the metal activity series in the liquid alloy is: hafnium>zirconium, the zirconium is reduced prior to the hafnium and migrates into the liquid alloy, whereas the hafnium remains in the anode electrolyte. According to the above-mentioned metal activity series, the hafnium in the liquid alloy is oxidized prior to the zirconium, the hafnium in ionic form migrates into the cathode electrolyte. In the above-mentioned process, because the hafnium is oxidized and migrates into the cathode electrolyte prior to the zirconium, the content of the hafnium in the liquid alloy continuously decreases, therefore achieving the separation of zirconium and hafnium.

In the above-mentioned electrolysis process, when the material of the anode is graphite or zirconium, the zirconium in the anode electrolyte in the anode chamber continuously migrates into the liquid alloy, meanwhile the hafnium in the liquid alloy continuously migrates into the cathode electrolyte in the cathode chamber, therefore achieving the separation of zirconium and hafnium; when the material of the anode is copper, the copper in the anode electrolyte in the anode chamber continuously migrates into the liquid alloy, meanwhile the hafnium in the liquid alloy continuously migrates into the cathode electrolyte in the cathode chamber, therefore achieving the separation of zirconium and hafnium. And the liquid alloy can be directly used as the anode for electrolysis to separate the hafnium in the liquid alloy.

The beneficial effects of the present disclosure are:

The present disclosure provides an electrochemical method for the separation of zirconium and hafnium, using an electrolytic cell equipped with an anode chamber and a cathode chamber, wherein the anode chamber and the cathode chamber are separated by a liquid alloy. In particular, the liquid alloy comprises crude zirconium and a matrix metal with the metal activity lower than zirconium. After the electrolysis reaction is started, since the metal activity series in the liquid alloy is: hafnium>zirconium>>matrix metal, the hafnium in the liquid alloy is oxidized prior to the zirconium, the hafnium in ionic form migrates into the cathode electrolyte in the cathode chamber, leading to a continuous decrease of hafnium content in the liquid alloy, whereas the zirconium remains in the liquid alloy. Accordingly, deep separation of zirconium and hafnium is achieved, and therefore, nuclear-grade zirconium products can be prepared.

### BRIEF DESCRIPTION OF THE DRAWINGS

FIG. 1 is a schematic structural diagram of the electrolytic cell of the present disclosure.

Where, 1—anode; 2—anode chamber; 3—liquid alloy; 4—cathode chamber; 5—cathode; 6—cell body; 7—resistance wire; 8—air inlet; 9—air outlet; 10—zirconium-containing material feed port; 11—liquid alloy feed port.

### DETAILED DESCRIPTION OF THE EMBODIMENTS

To make the purpose, technical solutions and advantages of the present disclosure clearer, the technical solutions of the present disclosure will be described in detail below. Obviously, the described embodiments are only a part of the embodiments of the present disclosure, but are not all of the embodiments. Based on the embodiments in the present disclosure, all other implementations obtained by those of ordinary skill in the art without any creative work fall within the scope of protection of the present disclosure.

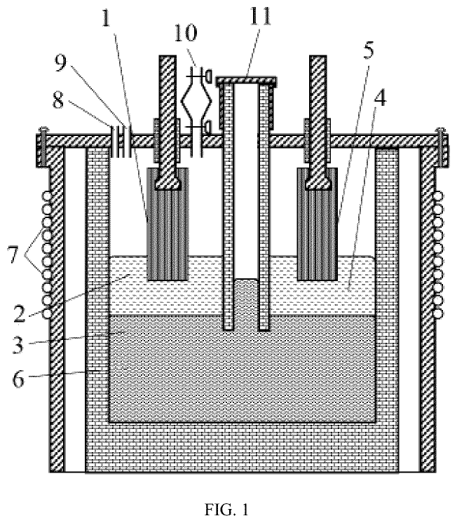

The embodiments of the present disclosure relate to an electrochemical method for separating zirconium and hafnium, and the method is carried out in an electrolytic cell. As shown in FIG. 1, the main body of the electrolytic cell used in the present disclosure is the cell body 6, the electrolytic cell has an anode chamber 2 and a cathode chamber 4, wherein there are an anode electrolyte and an anode 1 in the anode chamber 2, there are a cathode electrolyte and a cathode 5 in the cathode chamber 4, the anode chamber 2 and the cathode chamber 4 are separated by a liquid alloy 3. In FIG. 1, there is a connected section at lower body of the inside of the cell body 6 and the liquid alloy 3 is filled in the connected section, the anode chamber 2 and the cathode chamber 4 are respectively at the upper body of the inside of the cell body 6. The interface formed by the liquid alloy 3 and the electrolyte defines the regions of the anode chamber 2 and the cathode chamber 4, and both cathode 5 and the anode 1 are not in contact with the liquid alloy 3.

The cell body 6 is an enclosed structure in overall view, there is an air inlet 8 at the top of the cell body 6 for the entry of inert gas, and there is an air outlet 9 at the top of the cell body 6 for the discharge of gases from within the cell body 6. There is a zirconium-containing material feed port 10 at the top of the anode chamber, and there is a liquid alloy feed port 11 between the anode chamber 2 and the cathode chamber 4. There is a resistance wire on the outer surface of the cell body 6 for heating.

After the electrolysis is carried out for a certain period of time, the liquid alloy can be directly subjected to electrolytic separation, and the solute metal zirconium and the matrix metal in the liquid alloy are separated by electrolysis, achieving the extraction of zirconium from the liquid alloy; or after the cooling of the electrolysis reaction system, the metal phase and electrolyte are separated, and then the extraction from the liquid alloy is carried out. The extraction of zirconium from the liquid alloy can be achieved using general metallurgical separation methods (such as molten salt electrolytic oxidation to separate zirconium from the liquid alloy). The final zirconium product obtained contains less than 100 ppm hafnium, which meets the requirement for hafnium in the nuclear-grade zirconium products.

### Embodiment 1

The electrolysis reaction is carried out in the electrolytic cell as shown in FIG. 1, the matrix metal of 500 g is prepared from copper and tin at a mass ratio of 1:1, and 10 g of zirconium metal powder (wherein the hafnium content accounts for 2.2% of the total mass of zirconium and hafnium) as the solute metal is added into the matrix metal; the graphite rod is used as the anode, the stainless steel is used as the cathode, the refractory ceramic is used as the lining of the cell body, the anode electrolyte is prepared from NaCl and KCl at a mass ratio of 1:1 and 300 g of the anode electrolyte is added into the anode chamber, the cathode electrolyte is prepared from NaCl, KCl and ZrCl₃ at a mass ratio of 1:1:0.02 and 300 g of the cathode electrolyte is added into the cathode chamber, under the protection of argon atmosphere, the electrolytic cell is heated at a rate of 10° C./min to 800° C. and held at this temperature for 1 hour, potassium fluozirconate (wherein the hafnium content accounts for 2.2% of the total mass of zirconium and hafnium) is added to the anode chamber, meanwhile a voltage is applied for electrolysis, and the current density is controlled at 0.02 A·cm⁻², the zirconium ions in the anode electrolyte are continuously reduced to the zirconium metal and the zirconium metal continuously migrates into the liquid alloy, the hafnium metal in the liquid alloy is oxidized to the hafnium ions and the hafnium ions migrate into the cathode electrolyte, after 6 hours of electrolysis, a sample is taken from the liquid alloy feed port.

An elemental analysis is carried out on the metal phase in the liquid alloy, wherein the content of hafnium accounts for 0.007% of the total mass of zirconium and hafnium, which meets the requirement for the hafnium content in nuclear-grade zirconium.

### Embodiment 2

The matrix metal of 500 g is prepared from copper and tin at a mass ratio of 1:1, and 10 g of zirconium metal powder (wherein the hafnium content accounts for 2.2% of the total mass of zirconium and hafnium) as the solute metal is added into the matrix metal; the liquid alloy is directly used as an anode and connected to the electric current for electrolysis, the zirconium is used as the cathode, the refractory ceramic is used as the lining of the cell body, the cathode electrolyte is prepared from NaCl and K₂ZrF₆ at a mass ratio of 1:0.02 and 300 g of the cathode electrolyte is added into the cathode chamber, under the protection of argon atmosphere, the electrolytic cell is heated at a rate of 10° C./min to 900° C., the current density is controlled at 0.02 A cm⁻², after 1 hour of electrolysis, the liquid alloy is taken out.

An elemental analysis is carried out on the metal phase in the liquid alloy, wherein the content of hafnium accounts for 0.009% of the total mass of zirconium and hafnium, which meets the requirement for the hafnium content in nuclear-grade zirconium.

### Embodiment 3

The matrix metal of 500 g is prepared from copper and tin at a mass ratio of 1:1, and 10 g of zirconium metal powder (wherein the hafnium content accounts for 2.2% of the total mass of zirconium and hafnium) as the solute metal is added into the matrix metal; the copper rod is used as the anode, the stainless steel is used as the cathode, the refractory ceramic is used as the lining of the cell body, the anode electrolyte is prepared from NaCl and KCl at a mass ratio of 1:1 and 300 g of the anode electrolyte is added into the anode chamber, the cathode electrolyte is prepared from NaCl, KCl and ZrCl₂ at a mass ratio of 1:1:0.02 and 300 g of the cathode electrolyte is added into the cathode chamber, under the protection of argon atmosphere, the electrolytic cell is heated at a rate of 10° C./min to 900° C. and held at this temperature for 1 hour, a voltage is applied for electrolysis, and the current density is controlled at 0.015 A cm⁻², in the electrolysis process, the copper anode is continuously oxidized to the copper ions, the copper ions migrate into the anode electrolyte, the copper ions in the anode electrolyte are reduced to the copper metal at the interface between the anode electrolyte and the liquid alloy, and the copper metal migrates into the liquid alloy, meanwhile, the hafnium metal in the liquid alloy is oxidized to the hafnium ions, and the hafnium ions migrate into the cathode electrolyte, after 6 hours of electrolysis, a sample is taken from the liquid alloy feed port.

An elemental analysis is carried out on the metal phase in the liquid alloy, wherein the content of hafnium accounts for 0.005% of the total mass of zirconium and hafnium, which meets the requirement for the hafnium content in nuclear-grade zirconium.

### Embodiment 4

The electrolysis reaction is carried out in the electrolytic cell as shown in FIG. 1, the matrix metal of 500 g is prepared from copper and tin at a mass ratio of 1:1, and 10 g of zirconium metal powder (wherein the hafnium content accounts for 2.2% of the total mass of zirconium and hafnium) as the solute metal is added into the matrix metal; the zirconium metal (wherein the hafnium content accounts for 2.2% of the total mass of zirconium and hafnium) is used as the anode, the stainless steel is used as the cathode, the refractory ceramic is used as the lining of the cell body, the anode electrolyte is prepared from NaCl and KCl at a mass ratio of 1:1 and 300 g of the anode electrolyte is added into the anode chamber, the cathode electrolyte is prepared from NaCl, KCl and ZrCl₂ at a mass ratio of 1:1:0.02 and 300 g of the cathode electrolyte is added into the cathode chamber, under the protection of argon atmosphere, the electrolytic cell is heated at a rate of 10° C./min to 900° C. and held at this temperature for 1 hour, a voltage is applied for electrolysis and the current density is controlled at 0.02 A·cm⁻², the zirconium ions in the anode electrolyte are continuously reduced to the zirconium metal and the zirconium metal continuously migrate into the liquid alloy, the hafnium metal in the liquid alloy is oxidized to the hafnium ions and the hafnium ions migrate into the cathode electrolyte, after 6 hours of electrolysis, a sample is taken from the liquid alloy feed port.

An elemental analysis is carried out on the metal phase in the liquid alloy, wherein the content of hafnium accounts for 0.007% of the total mass of zirconium and hafnium, which meets the requirement for the hafnium content in nuclear-grade zirconium.

### Embodiment 5

The electrolysis reaction is carried out in the electrolytic cell as shown in FIG. 1, the matrix metal of 500 g is prepared from copper and tin at a mass ratio of 1:1, and 10 g of zirconium metal powder (wherein the hafnium content accounts for 2.2% of the total mass of zirconium and hafnium) as the solute metal is added into the matrix metal; the graphite rod is used as the anode, the stainless steel is used as the cathode, the refractory ceramic is used as the lining of the cell body, the anode electrolyte is prepared from NaCl, KCl and NaF at a mass ratio of 1:1:0.1 and 300 g of the anode electrolyte is added into the anode chamber, the cathode electrolyte is prepared from NaCl, KCl and ZrCl₃ at a mass ratio of 1:1:0.01 and 300 g of the cathode electrolyte is added into the cathode chamber, under the protection of argon atmosphere, the electrolytic cell is heated at a rate of 10° C./min to 900° C. and held at this temperature for 1 hour, potassium fluozirconate (wherein the hafnium content accounts for 2.2% of the total mass of zirconium and hafnium) is added to the anode chamber, meanwhile a voltage is applied for electrolysis, and the current density is controlled at 0.02 A·cm⁻², the zirconium ions in the anode electrolyte are continuously reduced to the zirconium metal and the zirconium metal continuously migrates into the liquid alloy, the hafnium metal in the liquid alloy is oxidized to the hafnium ions and the hafnium ions migrate into the cathode electrolyte, after 6 hours of electrolysis, a sample is taken from the liquid alloy feed port.

An elemental analysis is carried out on the metal phase in the liquid alloy, wherein the content of hafnium accounts for 0.007% of the total mass of zirconium and hafnium, which meets the requirement for the hafnium content in nuclear-grade zirconium.

### Embodiment 6

The electrolysis reaction is carried out in the electrolytic cell as shown in FIG. 1, the matrix metal of 500 g is prepared from copper and tin at a mass ratio of 1:1, and 10 g of zirconium metal powder (wherein the hafnium content accounts for 2.2% of the total mass of zirconium and hafnium) as the solute metal is added into the matrix metal; the graphite rod is used as the anode, the stainless steel is used as the cathode, the refractory ceramic is used as the lining of the cell body, the anode electrolyte is prepared from NaCl and KCl at a mass ratio of 1:1 and 300 g of the anode electrolyte is added into the anode chamber, the cathode electrolyte is prepared from NaCl, KCl and ZrCl₂ at a mass ratio of 1:1:0.02 and 300 g of the cathode electrolyte is added into the cathode chamber, under the protection of argon atmosphere, the electrolytic cell is heated at a rate of 10° C./min to 900° C. and held at this temperature for 1 hour, ZrO₂ (wherein the hafnium content accounts for 1.8% of the total mass of zirconium and hafnium) is slowly added to the anode chamber, meanwhile a voltage is applied for electrolysis, and the current density is controlled at 0.02 A cm⁻², the zirconium ions in the anode electrolyte are continuously reduced to the zirconium metal and the zirconium metal continuously migrates into the liquid alloy, the hafnium metal in the liquid alloy is oxidized to the hafnium ions and the hafnium ions migrate into the cathode electrolyte, after 6 hours of electrolysis, a sample is taken from the liquid alloy feed port.

An elemental analysis is carried out on the metal phase in the liquid alloy, wherein the content of hafnium accounts for 0.009% of the total mass of zirconium and hafnium, which meets the requirement for the hafnium content in nuclear-grade zirconium.

### Embodiment 7

The electrolysis reaction is carried out in the electrolytic cell as shown in FIG. 1, the matrix metal of 500 g is prepared from copper and tin at a mass ratio of 1:1, and 10 g of zirconium metal powder (wherein the hafnium content accounts for 5.2% of the total mass of zirconium and hafnium) as the solute metal is added into the matrix metal; the graphite rod is used as the anode, the stainless steel is used as the cathode, the refractory ceramic is used as the lining of the cell body, the anode electrolyte is prepared from NaCl and KCl at a mass ratio of 1:1 and 300 g of the anode electrolyte is added into the anode chamber, the cathode electrolyte is prepared from NaCl, KCl and ZrCl₂ at a mass ratio of 1:1:0.02 and 300 g of the cathode electrolyte is added into the cathode chamber under the protection of argon atmosphere, the electrolytic cell is heated at a rate of 10° C./min to 900° C. and held at this temperature for 1 hour, potassium fluozirconate (wherein the hafnium content accounts for 2.2% of the total mass of zirconium and hafnium) is added to the anode chamber, meanwhile a voltage is applied for electrolysis, and the current density is controlled at 0.02 A·cm⁻², the zirconium ions in the anode electrolyte are continuously reduced to the zirconium metal and the zirconium metal continuously migrates into the liquid alloy, the hafnium metal in the liquid alloy is oxidized to the hafnium ions and the hafnium ions migrate into the cathode electrolyte, after 6 hours of electrolysis, a sample is taken from the liquid alloy feed port.

An elemental analysis is carried out on the metal phase in the liquid alloy, wherein the content of hafnium accounts for 0.012% of the total mass of zirconium and hafnium.

### Embodiment 8

The electrolysis reaction is carried out in the electrolytic cell as shown in FIG. 1, the matrix metal of 500 g is prepared from copper and tin at a mass ratio of 9:1, and 90 g of zirconium metal powder (wherein the hafnium content accounts for 2.2% of the total mass of zirconium and hafnium) as the solute metal is added into the matrix metal; the zirconium metal (wherein the hafnium content accounts for 6.2% of the total mass of zirconium and hafnium) is used as the anode, the stainless steel is used as the cathode, the refractory ceramic is used as the lining of the cell body, the anode electrolyte is prepared from NaCl and KCl at a mass ratio of 1:1 and 300 g of the anode electrolyte is added into the anode chamber, the cathode electrolyte is prepared from NaCl, KCl and ZrCl₂ at a mass ratio of 1:1:0.02 and 300 g of the cathode electrolyte is added into the cathode chamber. Under the protection of argon atmosphere, the electrolytic cell is heated at a rate of 10° C./min to 950° C. and held at this temperature for 1 hour, and then a voltage is applied for electrolysis and the current density is controlled at 0.02 A·cm⁻², the zirconium ions in the anode electrolyte are continuously reduced to the zirconium metal and the zirconium metal continuously migrates into the liquid alloy, the hafnium metal in the liquid alloy is oxidized to the hafnium ions and the hafnium ions migrate into the cathode electrolyte, after 6 hours of electrolysis, a sample is taken from the liquid alloy feed port.

An elemental analysis is carried out on the metal phase in the liquid alloy, wherein the content of hafnium accounts for 0.013% of the total mass of zirconium and hafnium.

The change of parameters in Embodiment 9 and Embodiment 10 compared to Embodiment 1 are shown in Table 1, other parameters in Embodiment 9 and Embodiment 10 are the same as in Embodiment 1, the experimental results are also presented in Table 1.

TABLE 1

| | Composition | | | | | | | | |
|---|---|---|---|---|---|---|---|---|---|
| Embodi- | of the liquid | Electrolysis | The anode | The cathode | | | Current | Raw | Product |
| ment | alloy | temperature | electrolyte | electrolyte | Anode | Cathode | density | material | purity |
| 1 | 500g Cu:Sn | 800° C. | 300 g | 300 g | graphite | stainless | 0.02 | Potassium | Hf/ |
| | wt. % = 1:1 | | NaCl:KCl | NaCl:KCl: | | steel | A · cm⁻² | fluoro- | (Zr + Hf) = |
| | Then add | | wt. % = 1:1 | ZrCl₂ | | | | zirconate | 0.007% |
| | 10 g | | | wt. % = | | | | | |
| | zirconium | | | 1:1:0.02 | | | | | |
| | powder (Hf | | | | | | | | |
| | content is | | | | | | | | |
| | 2.2 wt.%) | | | | | | | | |
| 9 | 500 g Bi | 400° C. | 300 g | 300 g | graphite | Tungsten | 0.002 | Potassium | Hf/ |
| | Then add 1 g | | LiCl:KCl | LiCl:KCl: | | | A · cm⁻² | fluoro- | (Zr + Hf) = |
| | zirconium | | wt. % = 1:1 | K₂ZrF₆ | | | | zirconate | 0.005% |
| | powder (Hf | | | wt. % = | | | | | |
| | content is | | | 1:1:0.02 | | | | | |
| | 1.8 wt. %) | | | | | | | | |
| 10 | 500 g Cu | 1100° C. | 300 g | 300 g | graphite | stainless | 0.5 | ZrO₂ | Hf/ |
| | Then add | | CaCl₂ | NaCl:KCl: | | steel | A · cm⁻² | | (Zr + Hf) = |
| | 90 g | | | K₂ZrF₆ | | | | | 0.009% |
| | zirconium | | | wt. % = | | | | | |
| | powder (Hf | | | 2:1:0.02 | | | | | |
| | content is | | | | | | | | |
| | 2.2 wt. %) | | | | | | | | |

### Comparative Embodiment 1

The electrolysis reaction is carried out in the electrolytic cell as shown in FIG. 1, the matrix metal of 500 g is prepared from copper and tin at a mass ratio of 9:1; the graphite rod is used as the anode, the stainless steel is used as the cathode, the refractory ceramic is used as the lining of the cell body, the anode electrolyte is prepared from NaCl and KCl at a mass ratio of 1:1 and 300 g of the anode electrolyte is added into the anode chamber, the cathode electrolyte is prepared from NaCl, KCl and ZrCl₄ at a mass ratio of 1:1:0.02 and 300 g of the cathode electrolyte is added into the cathode chamber, under the protection of argon atmosphere, the electrolytic cell is heated at a rate of 10° C./min to 800° C. and held at this temperature for 1 hour, potassium fluozirconate (wherein the hafnium content accounts for 2.2% of the total mass of zirconium and hafnium) is added to the anode chamber, meanwhile a voltage is applied for electrolysis, after 6 hours of electrolysis, a sample is taken from the liquid alloy feed port.

An elemental analysis is carried out on the metal phase in the liquid alloy, wherein the content of zirconium is low, therefore the separation of zirconium and hafnium is not achieved.

### Comparative Embodiment 2

The electrolysis reaction is carried out in the electrolytic cell as shown in FIG. 1, the matrix metal of 500 g is prepared from copper and tin at a mass ratio of 9:1, and 90 g of zirconium metal powder (wherein the hafnium content accounts for 2.2% of the total mass of zirconium and hafnium) is added into the matrix metal as the solute metal; the graphite rod is used as the anode, the stainless steel is used as the cathode, the refractory ceramic is used as the lining of the cell body, the anode electrolyte is prepared from NaCl and KCl at a mass ratio of 1:1 and 300 g of the anode electrolyte is added into the anode chamber, the cathode electrolyte is prepared from NaCl, KCl and ZrCl₄ at a mass ratio of 1:1:0.02 and 300 g of the cathode electrolyte is added into the cathode chamber, under the protection of argon atmosphere, the electrolytic cell is heated at a rate of 10° C./min to 800° C. and held at this temperature for 1 hour, after 6 hours of electrolysis, a sample is taken from the liquid alloy feed port.

An elemental analysis is carried out on the metal phase in the liquid alloy, the ratio of zirconium and hafnium in the alloy is not changed.

The above are only specific embodiments of the present disclosure, however, the protection scope of the present disclosure is not limited thereto, any modifications or substitutions readily apparent to those skilled in the art within the technical scope disclosed by the present disclosure should be encompassed within the scope of protection of the present disclosure. Therefore, the protection scope of the present disclosure should be subject to the protection scope of the claims.

1. An electrochemical method for the separation of zirconium and hafnium, the method comprises:
An electrolytic cell equipped with an anode chamber and a cathode chamber is used, wherein there is an anode electrolyte in the anode chamber and there is a cathode electrolyte in the cathode chamber, an anode is inserted into the anode electrolyte, a cathode is inserted into the cathode electrolyte: the anode chamber and the cathode chamber are separated by a liquid alloy, and both the anode and the cathode are not in contact with the liquid alloy;
the liquid alloy comprises solute metal and matrix metal, the solute metal is crude zirconium, the crude zirconium contains hafnium element: the metal activity of the matrix metal is lower than the metal activity of zirconium;
applying electrical current for electrolysis, the hafnium content in the liquid alloy continuously decreases, whereas the zirconium remains in the liquid alloy, therefore the separation of zirconium from hafnium is achieved.

2. An electrochemical method for the separation of zirconium and hafnium according to claim 1, the material of the anode is selected from one of graphite, copper, and zirconium.

3. An electrochemical method for the separation of zirconium and hafnium according to claim 2, when the material of the anode is graphite, a zirconium-containing material is added into the anode chamber, the zirconium-containing material is a halide of zirconium or an oxide of zirconium.

4. An electrochemical method for the separation of zirconium and hafnium according to claim 3, the zirconium-containing material is selected from one or several of Na₂ZrCl₆, K₂ZrCl₆, Na₂ZrF₆, K₂ZrF₆, ZrO₂, ZrCl₂, ZrCl₃, ZrCl₄.

5. An electrochemical method for the separation of zirconium and hafnium according to claim 2, when the material of the anode is copper or crude zirconium, there is no need to add a zirconium-containing material into the anode chamber.

6. An electrochemical method for the separation of zirconium and hafnium according to claim 1, the matrix metal is selected from one or several of copper, lead, zinc, tin, bismuth, and the melting point of the liquid alloy formed by the solute metal and the matrix metal is lower than 1100° C.

7. An electrochemical method for the separation of zirconium and hafnium according to claim 2, when the material of the anode is copper, the anode electrolyte is selected from one or several of CuCl₂ and LiF, NaF, KF, LiCl, NaCl, KCl, CaCl₂; when the material of the anode is graphite or zirconium, the anode electrolyte is selected from one or several of ZrCl₄, ZrCl₂, ZrCl₃, Na₂ZrF₆, K₂ZrF₆ or one or several of LiF, NaF, KF, LiCl, NaCl, KCl, CaCl₂;
the cathode electrolyte is selected from one or several of LiF, NaF, KF, LiCl, NaCl, KCl, CuCl₂, there are a zirconium halide and/or a hafnium halide dissolved in the cathode electrolyte, and the zirconium halide and/or the hafnium halide are selected from one or several of ZrCl₄, ZrCl₂, ZrCl₃, HfCl₄, HfCl₂, HfCl₃, Na₂ZrCl₆, K₂ZrCl₆, Na₂HfCl₆, K₂HfCl₆, Na₂ZrF₆, K₂ZrF₆, Na₂HfF₆, K₂HfF₆.

8. An electrochemical method for the separation of zirconium and hafnium according to claim 7, the zirconium halide and/or the hafnium halide are dissolved in the cathode electrolyte.

9. An electrochemical method for the separation of zirconium and hafnium according to claim 1, the material of the cathode is stainless steel, zirconium, titanium or tungsten.

10. An electrochemical method for the separation of zirconium and hafnium according to claim 1, the electrolysis reaction is carried out under the protection of the argon gas, the electrolysis reaction temperature is 400-1100° C., the anode current density is controlled at 0.002-0.5 A·cm⁻².
